(19) United States
(12) Patent Application Publication
(10) Pub. No.: US 2026/0287809 A1
(43) Pub. Date: Sep. 24, 2026

(54) LINEARLY LIGHT-EMITTING ELEMENT, LAMP ASSEMBLY AND MOTOR VEHICLE

(71) Applicant: VALEO VISION, Bobigny (FR)

(72) Inventors: Fengqiao LI, Foshan (CN); Changqi WU, Foshan (CN); Wenqing CHEN, Foshan (CN); Junlun DONG, Foshan (CN); Jiehong LONG, Foshan (CN); Yinfeng CHENG, Foshan (CN); Hongze LUO, Foshan (CN); Zhifeng LI, Foshan (CN)

(73) Assignee: VALEO VISION, Bobigny (FR)

(21) Appl. No.: 19/473,340

(22) PCT Filed: Apr. 8, 2024
(86) PCT No.: PCT/EP2024/059494

§ 371 Date: Oct. 7, 2025

(30) Foreign Application Priority Data
Apr. 7, 2023 (CN) 202320761117.6
Apr. 7, 2023 (CN) 202320778140.6
Jun. 30, 2023 (CN) 202310799959.5

(51) Int. Cl. F21V 8/00; F21S 43/237

(52) U.S. Cl. CPC G02B 6/001; F21S 43/237

(57) ABSTRACT

A linearly light-emitting element including a core layer, which is rod-shaped and at least one end side of which is configured to receive and input light from a light source, a cladding layer enveloping the outside of the core layer, wherein the refractive index of the cladding layer is lower than that of the core layer, and light from the core layer enters the cladding layer through refraction. At least one layer of the linearly light-emitting element is a colored layer.

### TECHNICAL FIELD

Embodiments of the present invention relate generally to the field of lighting and/or signaling, in particular to a linearly light-emitting element, a lamp assembly and a motor vehicle.

### BACKGROUND OF THE INVENTION

Linearly light-emitting elements, such as optical fibers, are often used in motor vehicles to provide specific lighting and/or signal indication functions, for example, are used in rear lights, daytime running lights, parking lights, indicator lights, etc., or as ambient lights in a driver's compartment to enhance the atmosphere. In addition, in accordance with regulations on lights of motor vehicles, lights with different functions should emit light with different colors, wherein, for example, in accordance with China's lighting regulations, brake lights should be able to emit red light, daytime running lights should emit white light, indicator lights should be able to emit amber light, and so on.

In the prior art, a linearly light-emitting element is usually composed of a core layer and a cladding layer enveloping the outside of the core layer, wherein the core layer and the cladding layer are transparent colorless or slightly white layers. If the outer lens of a lamp is also a transparent colorless, slightly white or slightly smoky layer, then for a lamp that needs to emit colored light, due to the mixing of sunlight and colored light emitted by the light-emitting element in plenty of sunlight during the day, the color of light finally presented by the lamp will fade, failing to meet requirements.

### SUMMARY OF THE INVENTION

An objective of the present invention is to solve or overcome at least one of the above and other problems and shortcomings in the prior art.

According to one aspect of the present invention, a linearly light-emitting element is provided, comprising:
a core layer, which is rod-shaped and at least one end side of which is configured to receive and input light from a light source;
a cladding layer enveloping the outside of the core layer, wherein the refractive index of the cladding layer is lower than that of the core layer, and light from the core layer enters the cladding layer through refraction;
wherein at least one layer of the linearly light-emitting element is a colored layer.

In some embodiments, the linearly light-emitting element has a laterally light-exiting region and further comprises a reflective layer formed on the outside of the cladding layer, the reflective layer being configured to reflect light from the cladding layer towards the laterally light-exiting region;
wherein at least one layer of the linearly light-emitting element, comprising the reflective layer, is a colored layer.

In some embodiments, the reflective layer of the linearly light-emitting element at least partially covers the outside of the cladding layer.

In some embodiments, the reflective layer is configured to cover at least half of the area of the outer peripheral surface of the cladding layer.

In some embodiments, the linearly light-emitting element further comprises a transparent light exit layer at least partially covering the outside of the cladding layer, the transparent light exit layer being configured to transmit light from the cladding layer and the reflective layer;
wherein at least one layer of the linearly light-emitting element, comprising the transparent light exit layer, is a colored layer.

In some embodiments, the transparent light exit layer is connected to the reflective layer on the outer peripheral surface of the cladding layer to jointly envelop the outer peripheral surface of the cladding layer.

In some embodiments, the laterally light-exiting region comprises at least a portion of the outer peripheral surface of the transparent light exit layer.

In some embodiments, the linearly light-emitting element further comprises:
a transparent light exit layer which envelops an outer peripheral surface of the cladding layer, the transparent light exit layer being configured to transmit light from the cladding layer;
the reflective layer is opaque and partially covers the outer peripheral surface of the transparent light exit layer, the reflective layer being configured to at least partially face the laterally light-exiting region to reflect light from the transparent light exit layer towards the laterally light-exiting region;
wherein at least one layer of the linearly light-emitting element, comprising the transparent light exit layer, is a colored layer.

In some embodiments, the reflective layer is configured to cover at least half of the area of the outer peripheral surface of the transparent light exit layer.

In some embodiments, the laterally light-exiting region comprises at least a portion of the outer peripheral surface of the transparent light exit layer.

In some embodiments, the core layer is a colorless layer, and the cladding layer and/or the reflective layer is a colored layer.

In some embodiments, the core layer is a colorless layer, and at least one of the cladding layer, the reflective layer, and the transparent light exit layer is a colored layer.

In some embodiments, at least one of the cladding layer, the reflective layer, and the transparent light exit layer is one of a red layer, an amber layer, a blue layer, or a green layer.

In some embodiments, the linearly light-emitting element comprises a flexible optical fiber which emits light laterally.

According to another aspect of the present invention, an embodiment further provides a lamp assembly comprising any of the linearly light-emitting elements as described above, and a light source module configured to emit light towards at least one end of the linearly light-emitting element.

In some embodiments, the light source module comprises a light-emitting element capable of emitting white light or colored light.

According to yet another aspect of the present invention, an embodiment further provides a motor vehicle comprising a lamp assembly as described above.

Other objectives and advantages of the present invention will become obvious through the following detailed description of the invention with reference to the drawings, which can also aid comprehensive understanding of the invention.

### BRIEF DESCRIPTION OF THE DRAWINGS

These and/or other aspects, features and advantages of the present invention will become obvious and easy to understand through the following description of illustrative embodiments in conjunction with the accompanying drawings, wherein:

FIG. 1 is a schematic perspective view of a linearly light-emitting element 1 according to a first embodiment of the present invention;

FIG. 2 is a schematic sectional view, taken along the line A-A, of the linearly light-emitting element 1 according to the first embodiment of the present invention in FIG. 1;

FIG. 3 is a schematic perspective view of a linearly light-emitting element 1 according to a second embodiment of the present invention;

FIG. 4 is a schematic sectional view, taken along the line B-B, of the linearly light-emitting element 1 according to the second embodiment of the present invention in FIG. 3; and

FIG. 5 is a schematic sectional view of a linearly light-emitting element 1 according to a third embodiment of the present invention.

### DETAILED DESCRIPTION OF THE INVENTION

Embodiments of the present invention will be described in detail below in conjunction with the accompanying drawings. Herein, identical or similar components are indicated by identical or similar reference numerals. The following explanation of embodiments of the present invention with reference to the accompanying drawings is intended to explain the overall disclosed concept of the present invention, and should not be interpreted as a limitation of the present invention.

In addition, in the following detailed description, for ease of explanation, many specific details are expounded to provide a comprehensive understanding of the embodiments of the present invention. However, it is obvious that one or more embodiments may also be implemented without these specific details. In other scenarios, well-known structures and devices are shown in the form of illustrations to simplify the drawings.

A lamp assembly according to an embodiment of the present invention comprises a linearly light-emitting element 1 and a light source module (not shown). Preferably, the lamp assembly can emit colored light that meets regulatory requirements or specific needs (such as styling requirements), where color refers to colors other than white, black, and grey. Examples of lamp assemblies include, but are not limited to, rear lights, brake lights, indicator lights, side marker lights, parking lights, daytime running lights, and ambient lights.

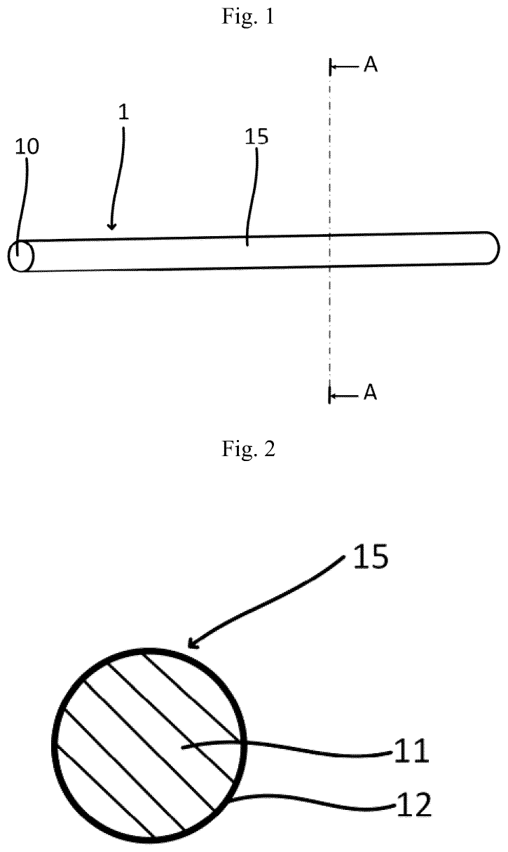

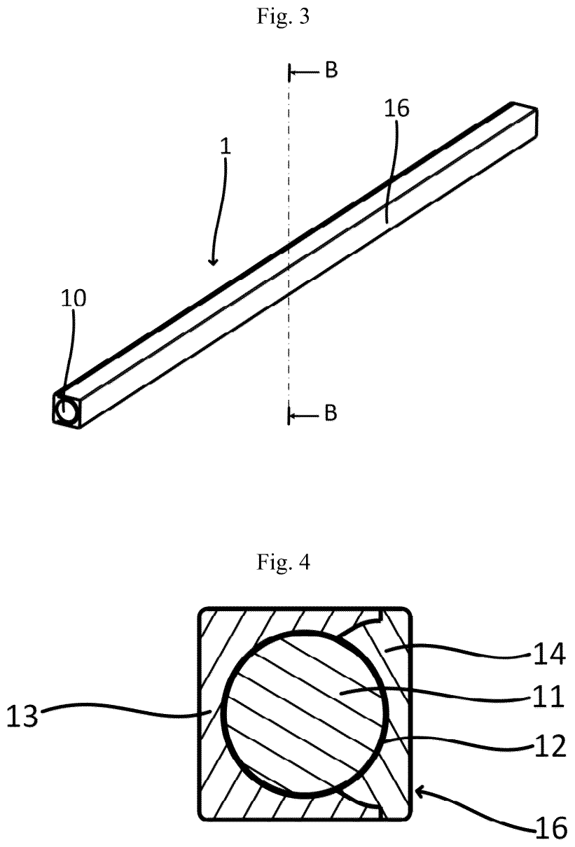

FIG. 1 and FIG. 3 are schematic perspective views of the linearly light-emitting element 1 according to the first and second embodiments of the present invention, respectively, wherein, as shown in FIG. 1, the linearly light-emitting element 1 according to an embodiment of the present invention is of a peripherally light-exiting type, which may comprise a peripherally light-exiting region 15, or, as shown in FIG. 3, the linearly light-emitting element 1 according to an embodiment of the present invention is of a laterally light-exiting type, which may comprise a laterally light-exiting region 15. The light source module is configured to emit light rays towards at least one end side 10 of the linearly light-emitting element 1, wherein these light rays enter one end side of the linearly light-emitting element 1 and then propagate longitudinally towards the opposite end side, and, at the same time, a portion of the light rays will emerge from at least a portion of the outer peripheral surface of the linearly light-emitting element 1, that is, from the peripherally light-exiting region 15 or laterally light-exiting region 16 of the linearly light-emitting element 1.

As a non-restrictive example, the light source module may comprise a printed circuit board and a light-emitting element, for example, an LED, installed on the printed circuit board. The light source module may be arranged on one end side or two opposite end sides of the linearly light-emitting element 1 as needed. The light-emitting element is capable of emitting white light or colored light.

Different structures of the linearly light-emitting element 1 will be described in detail below with reference to different embodiments.

### First Embodiment

FIG. 1 is a schematic perspective view of the linearly light-emitting element 1 according to the first embodiment of the present invention; FIG. 2 is a schematic sectional view, taken along the line A-A, of the linearly light-emitting element 1 according to the first embodiment of the present invention in FIG. 1. As shown in FIG. 1 and FIG. 2, the linearly light-emitting element 1 comprises a core layer 11, which is rod-shaped and made of a transparent material, wherein light from the light source module enters the interior of the core layer 11 through the end side 10, the light being able to propagate with total internal reflection along the longitudinal direction of the linearly light-emitting element 1 towards the other end side inside the core layer 11, and, in addition, while the core layer 11 has a circular cross-sectional shape in this embodiment, the first core layer 11 may also have an elliptical, polygonal, or any other suitable cross-sectional shape; and a cladding layer 12 enveloping the outside of the core layer 11, the cladding layer 12 being made of a transparent material and having a refractive index lower than that of the core layer 11, part of the light from the core layer 11 being able to enter the cladding layer 12 through refraction, wherein, for example, the cladding layer 12 may be made of a scattering material, or light extraction elements (including, but not limited to, optical protrusions, optical depressions, optical grain, and serrations) are constructed on the cladding layer 12, so that the condition for total reflection of part of the light in the core layer 11 is disrupted and thus the light enters the cladding layer 12.

It should be noted that, in the present invention, “transparent material” refers to a material capable of transmitting light, which may be completely transparent or semi-transparent, and may also have other percentage transmission or haze values, without specific restrictions thereto.

Preferably, the various layers of the linearly light-emitting element 1 may be formed integrally, for example, by one or more of a co-extrusion process, a perfusion process, and an injection molding process, in order to reduce costs and simplify processes.

In order to ensure that regulatory requirements or specific needs are still met when colored light emitted by the lamp assembly is mixed with sunlight, in the first embodiment of the present invention, the core layer 11 and/or cladding layer 12 of the linearly light-emitting element 1 are colored. Preferably, the core layer 11 of the linearly light-emitting element 1 is made colorless and transparent, while the cladding layer 12 is colored, so that the absorption of light by the core layer 11 is reduced and the light utilization efficiency is improved.

The linearly light-emitting element 1 with a colored layer matches a light-emitting element of the light source module that can emit the same colored light or white light. When the color of a colored layer of the linearly light-emitting element 1 is the same as the color of the light emitted by the light-emitting element of the light source module, the final light presented by the lamp assembly is caused to resemble more closely the color of the light emitted by the light-emitting element. When the linearly light-emitting element 1 with a colored layer matches a light-emitting element of the light source module that can emit white light, compared with using a light-emitting element that can emit colored light, the linearly light-emitting element absorbs less white light, thus achieving a higher optical efficiency, and, in another aspect, the color of the light finally presented by the lamp assembly is made lighter than that of a colored layer of the linearly light-emitting element 1.

In a non-restrictive example, the core layer 11 and/or cladding layer 12 of the linearly light-emitting element 1 is one of a red layer, an amber layer, a blue layer, or a green layer, wherein, for example, in the case where the core layer 11 and/or cladding layer 12 is a red layer, the linearly light-emitting element 1 may be used to implement a brake light, and in the case where the core layer 11 and/or cladding layer 12 is an amber layer, the linearly light-emitting element 1 may be used to implement an indicator light.

It should be noted that, in the present invention, a specific color refers to the color system of that color, wherein, for example, if both the core layer 11 and the cladding layer 12 are red layers, it means that both are red color systems and that their color values may be the same or different.

In the first embodiment of the present invention, as a result of making the core layer 11 and/or cladding layer 12 of the linearly light-emitting element 1 a colored layer, it is possible to ensure that even if the light emitted by the linearly light-emitting element 1 is mixed with sunlight when the linearly light-emitting element 1 is used in a lamp assembly, the final color of light will not fade, thereby meeting regulatory requirements or specific needs for the lamp assembly.

From another perspective, in the case where the lamp assembly is not turned on, since the linearly light-emitting element 1 has a colored layer, the lamp assembly is colored when not turned on, which is beneficial in cases where regulations or customers have special requirements for the lamp assembly to have a color when not turned on.

### 2. Second Embodiment

FIG. 3 is a schematic perspective view of the linearly light-emitting element 1 according to a second embodiment of the present invention; FIG. 4 is a schematic sectional view, taken along the line B-B, of the linearly light-emitting element 1 according to the second embodiment of the present invention in FIG. 3. As shown in FIG. 3 and FIG. 4, the linearly light-emitting element 1 according to the second embodiment of the present invention, like the linearly light-emitting element 1 according to the first embodiment, also comprises a core layer 11 and a cladding layer 12, and only its differences from the first embodiment will be described herein.

The linearly light-emitting element 1 according to the second embodiment of the present invention has a laterally light-exiting region 16, which means that only a portion of the outer peripheral surface emits light. Specifically, the linearly light-emitting element 1 further comprises a reflective layer 13 containing an opaque material, at least partially covering the outside of the cladding layer 12, facing the laterally light-exiting region 16, and configured to reflect light from the cladding layer 12 towards the laterally light-exiting region 16. As a result of providing the reflective layer containing the opaque material outside the cladding layer, the linearly light-emitting element no longer emits light throughout a 360-degree range, and instead emits light only in a required partial region (the laterally light-exiting region), thereby reducing light leakage and increasing optical efficiency. The overall brightness of the linearly light-emitting element is increased, being able to meet requirements even at minimum brightness.

Preferably, in order to cause more light to emerge through the laterally light-exiting region 16, the reflective layer 13 is configured to cover at least half of the area of the outer peripheral surface of the transparent light exit layer 12.

In order to ensure that regulatory requirements or specific needs are still met when colored light emitted by the lamp assembly is mixed with sunlight, in the second embodiment of the present invention, at least one of the core layer 11, cladding layer 12, and reflective layer 13 of the linearly light-emitting element 1 is colored. Preferably, the core layer 11 of the linearly light-emitting element 1 is made colorless and transparent, while the cladding layer 12 and/or reflective layer 13 is colored, so that the absorption of light by the core layer 11 is reduced and the light utilization efficiency is improved.

The linearly light-emitting element 1 with a colored layer matches a light-emitting element of the light source module that can emit the same colored light or white light. When the color of a colored layer of the linearly light-emitting element 1 is the same as the color of the light emitted by the light-emitting element of the light source module, the final light presented by the lamp assembly is caused to resemble more closely the color of the light emitted by the light-emitting element. When the linearly light-emitting element 1 with a colored layer matches a light-emitting element of the light source module that can emit white light, compared with using a light-emitting element that can emit colored light, the linearly light-emitting element absorbs less white light, thus achieving a higher optical efficiency, and, in another aspect, the color of the light finally presented by the lamp assembly is made lighter than that of a colored layer of the linearly light-emitting element 1.

In a non-restrictive example, at least one of the core layer 11 and cladding layer 12 of the linearly light-emitting element 1 is a red layer, an amber layer, a blue layer, or a green layer. For example, in the case where the linearly light-emitting element 1 is used to implement a brake light, the core layer 11 may be a colorless transparent layer, the cladding layer 12 may be a red layer, and the reflective layer 13 may be a white opaque layer, or the cladding layer 12 may be a colorless transparent layer, and the reflective layer 12 may be a red opaque layer, or both the cladding layer 12 and the reflective layer 13 may be red layers.

Further, as shown in FIG. 4, the linearly light-emitting element 1 according to the second embodiment of the present invention can further comprise a transparent light exit layer 14 made of transparent material and at least partially covering the outside of the cladding layer 12, which may specifically be arranged opposite to the reflective layer 13, and is configured to transmit light from the cladding layer 12 and the reflective layer 13. In other words, in this embodiment, the laterally light-exiting region 16 comprises a portion of the outer peripheral surface of the transparent light exit layer 14.

Preferably, the transparent light exit layer 14 and the reflective layer 13 are circumferentially connected on the outer peripheral surface of the cladding layer 12 to jointly envelop the outer peripheral surface of the cladding layer 12. In other words, the reflective layer 13 covers a portion of the cladding layer 12, and the transparent light exit layer 14 covers the rest of the cladding layer 12, wherein the two are circumferentially connected to avoid unexpected light leakage.

Preferably, the transparent light exit layer 14 may comprise scattering elements to scatter light from the cladding layer or reflective layer, and increase the uniformity of the illumination effect; for example but without limitation, the transparent light exit layer 14 may be made of a scattering material, or scattering units such as optical protrusions, optical depressions, optical grain and the like may be formed on an inner surface and/or an outer surface of the transparent light exit layer.

In the second embodiment of the present invention, the transparent light exit layer that covers the cladding layer can protect the cladding layer, preventing the cladding layer from being scratched, and thus avoiding undesirable bright spots caused by scratches on the cladding layer. In addition, the transparent light exit layer can also increase the abrasion resistance of the linearly light-emitting element.

Preferably, the various layers of the linearly light-emitting element 1 may be formed integrally, for example, by one or more of a co-extrusion process, a perfusion process, and an injection molding process, in order to reduce costs and simplify processes.

In order to ensure that regulatory requirements or specific needs are still met when colored light emitted by the lamp assembly is mixed with sunlight, in the case where the linearly light-emitting element 1 comprises a transparent light exit layer 14, at least one of the core layer 11, cladding layer 12, reflective layer 13, and transparent light exit layer 14 of the linearly light-emitting element 1 may be colored. Preferably, the core layer 11 of the linearly light-emitting element 1 is made colorless and transparent, so that at least one of the cladding layer 12, reflective layer 13, and transparent light exit layer 14 is colored, thereby reducing the absorption of light by the core layer 11 and improving light utilization efficiency.

In a non-restrictive example, at least one of the core 11, cladding layer 12, reflective layer 13, and transparent light exit layer 14 of the linearly light-emitting element 1 is one of a red layer, an amber layer, a blue layer, or a green layer. For example, in the case where the linearly light-emitting element 1 is used to implement a brake light, the core 11 and cladding layer 12 may be colorless transparent layers, the reflective layer 13 may be a white opaque layer, and the transparent light exit layer 14 may be a red layer, or the reflective layer 13 may be a red opaque layer, and the transparent light exit layer 14 may be a colorless transparent layer, or both the reflective layer 13 and the transparent light exit layer 14 may be red layers.

In the second embodiment of the present invention, as a result of making at least one of the core layer 11, cladding layer 12, reflective layer 13, and transparent light exit layer 14 (if any) of the linearly light-emitting element 1 a colored layer, it is possible to ensure that even if the light emitted by the linearly light-emitting element 1 is mixed with sunlight when the linearly light-emitting element 1 is used in a lamp assembly, the final color of light will not fade, thereby meeting regulatory requirements or specific needs for the lamp assembly.

From another perspective, in the case where the lamp assembly is not turned on, since the linearly light-emitting element 1 has a colored layer, the lamp assembly is colored when not turned on, which is beneficial in cases where regulations or customers have special requirements for the lamp assembly to have a color when not turned on.

### 3. Third Embodiment

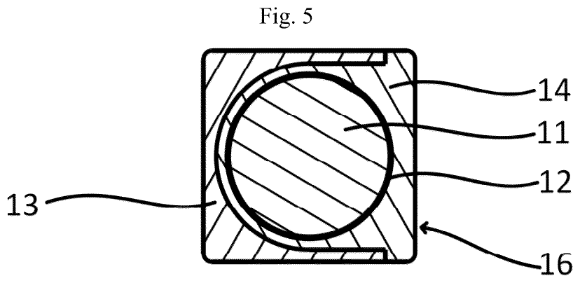

FIG. 5 is a schematic sectional view of a linearly light-emitting element 1 according to a third embodiment of the present invention. The linearly light-emitting element 1 according to the third embodiment of the present invention, like the first embodiment, also comprises a core layer 11 and a cladding layer 12, and only its differences from the first embodiment will be described herein.

As shown in FIG. 5, the linearly light-emitting element 1 according to the third embodiment of the present invention has a laterally light-exiting region 16, which means that only a portion of the outer peripheral surface emits light. Specifically, the linearly light-emitting element 1 further comprises a reflective layer 13 and a transparent light exit layer 14, wherein the transparent light exit layer 14 covers the outer peripheral surface of the cladding layer 12, that is, completely covering the outer peripheral surface of the cladding layer 12, the transparent light exit layer 14 is formed of a transparent material and configured to transmit light from the cladding layer 12, and the laterally light-exiting region 16 of the linearly light-emitting element 1 comprises at least a portion of the outer peripheral surface of the transparent light exit layer 14. The reflective layer 13 at least partially covers the outer peripheral surface of the transparent light exit layer 14, thereby being isolated from the cladding layer 12, that is, being not in contact with the cladding layer 12, the reflective layer 13 contains an opaque material and is configured to at least partially face the laterally light-exiting region 16 to reflect light from the transparent light exit layer 14 towards the laterally light-exiting region 16, and reflected light will again pass through the transparent light exit layer 14, cladding layer 12, and core layer 11 to reach the laterally light-exiting region 16.

In an embodiment of the present invention, as a result of providing the reflective layer containing the opaque material outside the cladding layer, the linearly light-emitting element no longer emits light throughout a 360-degree range, and instead emits light only in a required partial region (the laterally light-exiting region), thereby reducing light leakage and increasing optical efficiency. The overall brightness of the linearly light-emitting element is increased, being able to meet requirements even at minimum brightness.

In an embodiment of the present invention, the transparent light exit layer that covers the cladding layer can protect the cladding layer, preventing the cladding layer from being scratched, and thus avoiding undesirable bright spots caused by scratches on the cladding layer. In addition, the transparent light exit layer can also increase the abrasion resistance of the linearly light-emitting element.

In an embodiment of the present invention, if the reflective layer covers a portion of the outer peripheral surface of the cladding layer, in the case where there is poor adhesion between the material of the cladding layer and the material of the reflective layer, for example but without limitation, in the case where the cladding layer is formed of a fluorine-containing material, an air gap will appear between the cladding layer and the reflective layer, and since the cladding layer is transparent and the reflective layer is opaque, the air gap will be very conspicuous, severely impacting appearance. Therefore, in an embodiment of the present invention, the transparent light exit layer envelops the cladding layer, so that even if an air gap appears, since both layers are transparent, the air gap is inconspicuous.

Preferably, in order to cause more light to emerge through the laterally light-exiting region 16, the reflective layer 13 is configured to cover at least half of the area of the outer peripheral surface of the transparent light exit layer 14.

Preferably, the transparent light exit layer 14 may comprise scattering elements to scatter light from the cladding layer or reflective layer, and increase the uniformity of the illumination effect; for example but without limitation, the transparent light exit layer 14 may be made of a scattering material, or scattering units such as optical protrusions, optical depressions, optical grain and the like may be formed on an inner surface and/or an outer surface of the transparent light exit layer.

Preferably, the various layers of the linearly light-emitting element 1 are formed as a whole, for example, by one or more of co-extrusion, injection molding, or injection molding processes to reduce costs and simplify the process.

In order to ensure that regulatory requirements or specific needs are still met when colored light emitted by the lamp assembly is mixed with sunlight, at least one of the core layer 11, cladding layer 12, reflective layer 13, and transparent light exit layer 14 of the linearly light-emitting element 1 may be colored. Preferably, the core layer 11 of the linearly light-emitting element 1 is made colorless and transparent, so that at least one of the cladding layer 12, reflective layer 13, and transparent light exit layer 14 is colored, thereby reducing the absorption of light by the core layer 11 and improving light utilization efficiency.

In a non-restrictive example, at least one of the core 11, cladding layer 12, reflective layer 13, and transparent light exit layer 14 of the linearly light-emitting element 1 is one of a red layer, an amber layer, a blue layer, or a green layer. For example, in the case where the linearly light-emitting element 1 is used to implement an indicator light, the core 11 and cladding layer 12 may be colorless transparent layers, the reflective layer 13 may be a white opaque layer, and the transparent light exit layer 14 may be an amber layer, or the reflective layer 13 may be an amber opaque layer, and the transparent light exit layer 14 may be a colorless transparent layer, or both the reflective layer 13 and the transparent light exit layer 14 may be amber layers.

In the third embodiment of the present invention, as a result of making at least one of the core layer 11, cladding layer 12, reflective layer 13, and transparent light exit layer 14 of the linearly light-emitting element 1 a colored layer, it is possible to ensure that even if the light emitted by the linearly light-emitting element 1 is mixed with sunlight when the linearly light-emitting element 1 is used in a lamp assembly, the final color of light will not fade, thereby meeting regulatory requirements or specific needs for the lamp assembly.

From another perspective, in the case where the lamp assembly is not turned on, since the linearly light-emitting element 1 has a colored layer, the lamp assembly is colored when not turned on, which is beneficial in cases where regulations or customers have special requirements for the lamp assembly to have a color when not turned on.

Further, among embodiments of the present invention, as a non-restrictive embodiment, the linearly light-emitting element 1 may comprise a flexible optical fiber which emits light laterally and is bendable as needed, but the present invention, rather than being limited thereto, may also be any other suitable type of light-emitting element.

An embodiment of the present invention further provides a motor vehicle comprising a lamp assembly as described in any of the above embodiments.

Although the present invention has been explained in conjunction with the drawings, the embodiments disclosed in the drawings are intended to provide an exemplary illustration of preferred embodiments of the present invention, and must not be interpreted as a limitation of the present invention. The dimensional proportions in the drawings are merely schematic, and must not be interpreted as a limitation of the present invention.

Although some embodiments of the overall concept of the present invention have been shown and explained, those skilled in the art will understand that changes may be made to these embodiments without departing from the principles and spirit of the overall disclosed concept.

The scope of the present invention is defined by the claims and their equivalents.

What is claimed is:

1. A linearly light-emitting element, comprising:
a core layer, which is rod-shaped, at least one end side of the core layer being configured to receive and input light from a light source;
a cladding layer, which envelops the outside of the core layer wherein the refractive index of the cladding layer is lower than that of the core layer, and light from the core layer enters the cladding layer through refraction;
wherein at least one layer of the linearly light-emitting element is a coloured layer.

2. The linearly light-emitting element according to claim 1, wherein the linearly light-emitting element has a laterally light-exiting region and further comprising a reflective layer formed on the outside of the cladding layer, the reflective layer being configured to reflect light from the cladding layer towards the laterally light-exiting region;
wherein at least one layer of the linearly light-emitting element, including the reflective layer, is a coloured layer.

3. The linearly light-emitting element according to claim 2, wherein the reflective layer of the linearly light-emitting element at least partially covers the outside of the cladding layer.

4. The linearly light-emitting element according to claim 3, wherein the reflective layer is configured to cover at least half of the area of the outer peripheral surface of the cladding layer.

5. The linearly light-emitting element according to claim 3, wherein the linearly light-emitting element includes a transparent light exit layer at least partially covering the outside of the cladding layer, the transparent light exit layer being configured to transmit light from the cladding layer and the reflective layer;
wherein at least one layer of the linearly light-emitting element, including the transparent light exit layer, is a coloured layer.

6. The linearly light-emitting element according to claim 5, wherein the transparent light exit layer is connected to the reflective layer on the outer peripheral surface of the cladding layer to jointly envelop the outer peripheral surface of the cladding layer.

7. The linearly light-emitting element according to claim 5, wherein the laterally light-exiting region includes at least a portion of the outer peripheral surface of the transparent light exit layer.

8. The linearly light-emitting element according to claim 2, wherein the linearly light-emitting element includes:
a transparent light exit layer enveloping the outer peripheral surface of the cladding layer, the transparent light exit layer being configured to transmit light from the cladding layer;
the reflective layer is opaque and partially covers the outer peripheral surface of the transparent light exit layer, the reflective layer being configured to at least partially face the laterally light-exiting region to reflect light from the transparent light exit layer towards the laterally light-exiting region;
wherein at least one layer of the linearly light-emitting element, including the transparent light exit layer, is a coloured layer.

9. The linearly light-emitting element according to claim 8, wherein the reflective layer is configured to cover at least half of the area of the outer peripheral surface of the transparent light exit layer.

10. The linearly light-emitting element according to claim 8, wherein the laterally light-exiting region includes at least a portion of the outer peripheral surface of the transparent light exit layer.

11. The linearly light-emitting element according to claim 2, wherein the core layer is a colourless layer, and in that the cladding layer and/or the reflective layer is a coloured layer.

12. The linearly light-emitting element according to claim 5, wherein the core layer is a colourless layer, and in that at least one of the cladding layer, the reflective layer, and the transparent light exit layer is a coloured layer.

13. The linearly light-emitting element according to claim 12, wherein at least one of the cladding layer, the reflective layer, and the transparent light exit layer is one of a red layer, an amber layer, a blue layer, or a green layer.

14. The linearly light-emitting element according to claim 1, wherein the linearly light-emitting element includes a flexible optical fibre which emits light laterally.

15. A lamp assembly, comprising:
a linearly light-emitting element, the linearly light-emitting element includes a core layer, which is rod-shaped, at least one end side of the core layer being configured to receive and input light from a light source, a cladding layer, which envelops the outside of the core layer, wherein the refractive index of the cladding layer is lower than that of the core layer, and light from the core layer enters the cladding layer through refraction, wherein at least one layer of the linearly light-emitting element is a coloured layer; and
a light source module configured to emit light towards at least one end side of the linearly light-emitting element.

16. The lamp assembly according to claim 15, wherein the light source module includes a light-emitting element capable of emitting white light or coloured light.

17. (canceled)
